(19) United States
(12) Patent Application Publication
(10) Pub. No.: US 2026/0302803 A1
(43) Pub. Date: Oct. 1, 2026

(54) Managing Information About a Battery Unit

(71) Applicant: LG ENERGY Solution, Ltd., Seoul (KR)

(72) Inventors: Yong Min Jo, Daejeon (KR); Sun Woo Yoon, Daejeon (KR)

(73) Assignee: LG ENERGY Solution, Ltd., Seoul (KR)

(21) Appl. No.: 19/475,777

(22) PCT Filed: Aug. 22, 2024
(86) PCT No.: PCT/KR2024/012484

§ 371 Date: Oct. 16, 2025

(30) Foreign Application Priority Data
Sep. 1, 2023 (KR) 10-2023-0116394

(51) Int. Cl. H02J 7/45; H04B 5/72

(52) U.S. Cl. CPC H02J 7/45; H04B 5/72

(57) ABSTRACT

Aspects of the disclosure are directed to managing battery passport information related to a management history of a battery through more efficient transmission of the battery passport information.

### CROSS-REFERENCE TO RELATED APPLICATION

This application is a national phase entry under 35 U.S.C. § 371 of International Application No. PCT/KR2024/012484, filed on Aug. 22, 2024, which claims priority to Korean Patent Application No. 10-2023-0116394, filed on Sep. 1, 2023, all of which are incorporated herein by reference.

### BACKGROUND

Secondary batteries are chargeable/dischargeable batteries and may include nickel (Ni)/cadmium (Cd) batteries, Ni/metal hydride (MH) batteries, and lithium-ion batteries. Among the secondary batteries, a lithium-ion battery has a higher energy density than the Ni/Cd batteries, Ni/MH batteries, etc. Moreover, the lithium-ion battery may be manufactured to be small and lightweight, such that the lithium-ion battery can be used as a power source of mobile devices. In addition, the lithium-ion battery can be utilized in an energy storage medium for use as a power source of electric vehicles.

A lithium-ion battery may include at least one battery unit. The battery unit is charged by being supplied with electricity, e.g., from an external charger, and discharged by releasing the electricity, e.g., to drive a motor. The battery unit undergoes internal deformation and denaturation through various charges and discharges during use, where physical and chemical characteristics of the battery unit may change, resulting in a degenerated or deteriorated battery unit.

Identifying, as well as repairing, a degenerated or deteriorated battery unit can be achieved through transmission and receipt of information about the battery unit. However, transmission and receipt of information about the battery unit may have identification and/or authentication issues. Further, transmission and receipt of information about the battery unit may have problems if a battery management apparatus associated with the battery unit is not operating.

### BRIEF SUMMARY

Aspects of the disclosure are directed to managing battery passport information related to a management history of a battery through more efficient transmission of the battery passport information.

An aspect of the disclosure provides for an electronic device including: a communication circuit configured to communicate with a communication module of a battery unit; and a processor configured to: receive battery identification information regarding the battery unit from the communication module; receive a request from a user; and in response to receiving the request from the user, request, from a server, at least a part of battery passport information related to a management history of the battery unit based on user information related to the user and the battery identification information.

In some examples, the processor is further configured to receive battery information regarding the battery unit from the communication module; and transmit the battery information to the server such that the battery information is managed as the battery passport information of the battery unit.

In some examples, the user information includes access authority information regarding the battery passport information.

In some examples, the processor is further configured to receive battery passport information corresponding to an access authority of the user from the server.

In some examples, the communication module includes a near field communication (NFC) module. In some examples, the NFC module includes memory configured to store the battery identification information and the battery information.

In some examples, the processor is further configured to: receive encrypted battery information stored in the memory of the NFC module; and decrypt the encrypted battery information.

In some examples, the battery passport information includes at least one of production information, use information, recycling information, or warranty information of the battery unit.

In some examples, the processor is further configured to request, from the server, information related to at least one of manufacturing information, warranty information, material information, predicted lifetime information, or renewable material content information of the battery unit in the battery passport information.

In some examples, the processor is further configured to request, from the server, information related to at least one of composition information, part replacement information, removal information, state information, or renewable material content information of the battery unit in the battery passport information.

In some examples, the processor is further configured to request information related to information about law compliance of the battery unit in the battery passport information.

Another aspect of the disclosure provides for a battery pack including: a battery unit including a communication module; and a battery management apparatus communicating with the communication module; wherein the communication module includes a processor configured to: communicate with an electronic device independently of an operating state of the battery management apparatus; receive battery information regarding the battery unit from the battery management apparatus; and transmit the battery information and battery identification information regarding the battery unit to the electronic device.

In some examples, the battery management apparatus includes: a first memory configured to store the battery information regarding the battery unit; and a controller configured to encrypt the battery information; and the communication module further includes a second memory configured to store battery information encrypted in the battery management apparatus.

Yet another aspect of the disclosure provides for an operating method of an electronic device including: receiving, by a processor, battery identification information regarding the battery unit from a communication module of a battery unit; receiving, by the processor, a request from a user; and in response to receiving the request from the user, requesting, by the processor, from a server, at least a part of battery passport information related to a management history of the battery unit based on user information related to a user and the battery identification information.

In some examples, the operating method further includes: receiving, by the processor, battery information regarding the battery unit from the communication module; and transmitting, by the processor, the battery information to the server such that the battery information is managed as the battery passport information of the battery unit.

In some examples, the user information includes access authority information regarding the battery passport information; and the operating method further comprises receiving battery passport information corresponding to an access authority of the user from the server.

In some examples, the operating method further includes: receiving, by the processor, encrypted battery information stored in a first memory of the communication module; and decrypting, by the processor, the encrypted battery information.

In some examples, the user information includes access authority information regarding the battery passport information; and the requesting of the at least a part of the battery passport information includes requesting, from the server, information related to at least one of manufacturing information, warranty information, material information, predicted lifetime information, or renewable material content information of the battery unit in the battery passport information.

In some examples, the user information includes access authority information regarding the battery passport information; and the requesting of the at least a part of the battery passport information includes requesting, from the server, information related to at least one of composition information, part replacement information, removal information, state information, or renewable material content information of the battery unit in the battery passport information.

In some examples, the user information includes access authority information regarding the battery passport information; and the requesting of the at least a part of the battery passport information includes requesting information related to information about law compliance of the battery unit in the battery passport information.

### BRIEF DESCRIPTION OF DRAWINGS

FIG. 1 depicts a block diagram of a network environment for a battery pack, electronic device, and server according to aspects of the disclosure.

FIG. 2 depicts a block diagram of a battery pack according to aspects of the disclosure.

FIG. 3 depicts a block diagram of a communication module according to aspects of the disclosure.

FIG. 4 depicts a block diagram of an electronic device according to aspects of the disclosure.

FIG. 5 depicts a swim diagram for an operating method of an electronic device for requesting battery passport information according to aspects of the disclosure.

FIG. 6 depicts a swim diagram for an operating method of an electronic device for storing battery passport information according to aspects of the disclosure.

FIG. 7 depicts a swim diagram for an operating method of an electronic device for encrypting/decryption battery information according to aspects of the disclosure.

### DETAILED DESCRIPTION

The disclosure may be modified in various forms and have various examples, and specific examples thereof are shown by way of drawings and description below. It should be understood, however, that there is no intent to limit the disclosure to the specific examples, but on the contrary, the disclosure is to cover all modifications, equivalents, and alternatives falling within the spirit and technical scope of the disclosure. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes combinations of a plurality of associated listed items or any of the plurality of associated listed items.

It will be understood that when an element is referred to as being “connected” to another element, it can be directly connected to the other element or an intervening element may be present.

The terms used herein are for the purpose of describing specific examples only and are not intended to limit the disclosure. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Aspects of the disclosure may be provided in a computer program product. The computer program product may be traded as a product between a seller and a buyer. The computer program product may be distributed in the form of a machine-readable storage medium, e.g., compact disc read only memory (CD-ROM)), or be distributed, e.g., downloaded or uploaded, online via an application store, or be distributed between two user devices directly. If distributed online, at least part of the computer program product may be temporarily generated or at least temporarily stored in the machine-readable storage medium, such as memory of the manufacturer's server, a server of the application store, or a relay server.

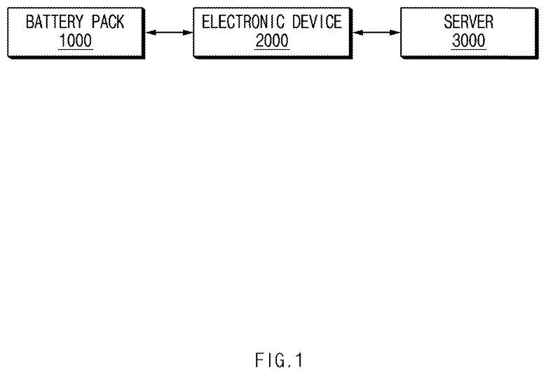

FIG. 1 depicts a block diagram of a network environment for a battery pack 1000, electronic device 2000, and server 3000 according to aspects of the disclosure.

A user of the electronic device 2000 may identify battery passport information related to the battery pack 1000 through the electronic device 2000. For example, the battery passport information may be information related to a management history of a battery unit in the battery pack 1000. The battery passport information may be generated based on battery information obtained from the battery pack 1000. For example, the battery information may include information about a use history of the battery pack 1000 and/or a state of the battery pack 1000.

The battery information may be generated in the battery pack 1000 and then transmitted to the server 3000 through the electronic device 2000. The battery information transmitted to the server 3000 may be managed as the battery passport information in the server 3000 related to a battery passport service. The battery passport information stored in the server 3000 may be provided to a user of the electronic device 2000.

The electronic device 2000 may receive the battery passport information from the server 3000 and provide the battery passport information to the user of the electronic device 2000. The electronic device 2000 may include any computing device, such as a personal computer, laptop computer, tablet computer, and/or mobile device, e.g., smartphone.

The electronic device 2000 may provide the battery information obtained from the battery pack 1000 to the server 3000. The electronic device 2000 may receive the battery information from the battery pack 1000 in response to user input and transmit the received battery information to the server 3000.

The electronic device 2000 may transmit a request for the battery passport information to the server 3000 based on user information of the user, related to the electronic device 2000, and identification information of the battery pack 1000. The electronic device 2000 may request at least a part of the battery passport information corresponding to the user information.

The server 3000 may store and/or manage the provided battery information as the battery passport information. The server 3000 may be a server on a wired or wireless network.

The server 3000 may store the battery passport information. The server 3000 may receive the battery information from the electronic device 2000 and manage the battery information as the battery passport information. The server 3000 may provide the battery passport information to the user.

The server 3000 may receive the battery information from the battery pack 1000 or the electronic device 2000 periodically or according to a preset communication condition and store/manage the battery passport information. The server 3000 may receive the battery information corresponding to the battery pack 1000 or the electronic device 2000 from another server without performing direct communication with the battery pack 1000 or the electronic device 2000 and store/manage the battery passport information.

The electronic device 2000 in the network environment may communicate with the battery pack 1000 via a first network, e.g., a short-range wireless communication network, or with at least one of the battery pack 1000 or the server 3000 via a second network, e.g., a long-range wireless communication network. The electronic device 2000 may communicate with the battery pack 1000 via the server 3000.

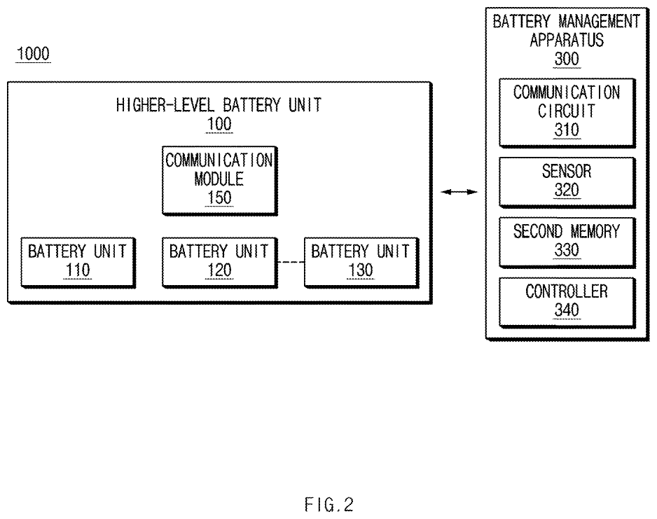

FIG. 2 depicts a block diagram of the battery pack 1000 according to aspects of the disclosure. The battery pack 1000 may include a higher-level battery unit 100 and a battery management apparatus 300.

The higher-level battery unit 100 may include a plurality of battery units 110, 120, . . . , 130. For example, when the higher-level battery unit 100 is a battery module, the plurality of battery units 110, 120, . . . , 130 may be a plurality of battery cells. The plurality of battery units 110, 120, . . . , 130 may be lithium ion (Li-ion) batteries, Li-ion polymer batteries, nickel-cadmium (Ni—Cd) batteries, and/or nickel hydrogen (Ni-MH) batteries, as examples. Although FIG. 2 depicts a single higher-level battery unit 100, the battery pack 1000 may include any number of higher-level battery units.

The higher-level battery unit 100 may supply power to a target device (not shown). To this end, the higher-level battery unit 100 may be electrically connected to the target device. The target device may include an electrical, electronic, and/or mechanical device that operates by receiving power from the battery pack 1000 including the higher-level battery unit 100. For example, the target device may be an electric vehicle (EV) and/or an energy storage system (ESS).

The higher-level battery unit 100 may include a communication module 150. The higher-level battery unit 100 may communicate with the battery management apparatus 300 through the communication module 150. The higher-level battery unit 100 may communicate with the external electronic device 2000 through the communication module 150. Although FIG. 2 depicts the communication module 150 as included in the higher-level battery unit 100, the communication module 150 may be included in each of the plurality of battery units 110, 120, . . . , 130.

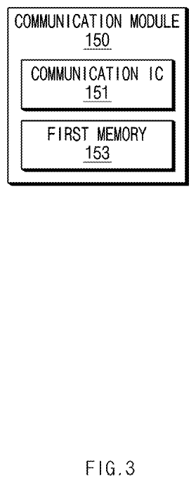

FIG. 3 depicts a block diagram of the communication module 150 according to aspects of the disclosure. The communication module 150 may include a communication integrated circuit (IC) 151 and a first memory 153.

The communication IC 151 may receive the battery information from the communication circuit 310 of the battery management apparatus 300. The communication IC 151 may wirelessly or wiredly communicate with the communication circuit 310 of the battery management apparatus 300. The communication IC 151 may transmit and receive data to and from the electronic device 2000 or the server 3000. For example, the communication IC 151 may provide the battery information stored in the first memory 153 of the communication module 150 to the electronic device 2000 or the server 3000.

The battery information may be information related to the state of the battery unit 100 including the communication module 150. For example, the battery information may include a state of charge (SOC), a state of health (SOH), a resistance, a current cycle, a remaining prediction cycle, and/or a C-rate.

The communication IC 151 may receive encrypted battery information from the battery management apparatus 300. The encrypted battery information may be information in which a data size and/or format of the battery information is changed.

The communication module 150 may include an NFC communication module. When the communication module 150 includes an NFC communication module, the communication IC 151 may include a radio frequency (RF) interface enabling RF communication. The communication IC 151 may transmit and receive an NFC signal to and from another device, e.g., the electronic device 2000, in a contactless manner. For example, the communication IC 151 may receive or transmit a signal in an NFC frequency band via an NFC antenna (not shown). The NFC antenna may include a conductive wire capable of receiving signals in a frequency band of 13 MHz to 110 MHz, as examples. For example, the NFC antenna may transmit and receive an NFC signal in a frequency band of 13.56 MHz.

The first memory 153 may store data used by other components of the communication module 150, e.g., the communication IC 151. The first memory 153 may store the battery identification information and/or the battery information received from the battery management apparatus 300. The first memory 153 may store encrypted battery identification information and/or encrypted battery information received from the battery management apparatus 300.

The battery identification information may include information for identifying the battery unit 100 including the communication module 150. For example, the battery identification information may include, but is not limited to, a product serial number of the higher-level battery unit 100. Thus, the battery management apparatus 300, the electronic device 2000, and/or the user may identify the battery unit 100 related to the communication module 150 through the battery identification information.

The communication module 150 may operate without a power source. For example, when the communication module 150 is an NFC module, the communication module 150 may may transmit and receive data to and from an external device through power generated in tagging of the NFC antenna of the external device, e.g., the electronic device 2000.

The communication module 150 may operate independently of the higher-level battery unit 100, the plurality of battery units 110, 120, . . . , 130, and/or the battery management apparatus 300. The communication module 150 may operate independently of an operating state of the battery management apparatus 300. For example, when the battery management apparatus 300 does not operate, the communication module 150 may communicate with an external electronic device. To this end, the communication module 150 may transmit and receive data to and from the external electronic device even when the battery management apparatus 300 does not operate. The communication module 150 may not use power from the higher-level battery unit 100, the plurality of battery units 110, 120, . . . , 130, and/or the battery management apparatus 300 and communicate with the external electronic device, without causing a loss of the power of the battery pack 1000. Thus, even when the battery management apparatus 300 is turned off, data stored in the first memory 153 of the communication module 150 may be transmitted to the external device, thereby preventing over-discharge from occurring due to consumed current of the battery management apparatus 300.

The communication module 150 may include a wireless communication module, e.g., a cellular communication module, a short-range wireless communication module, or a global navigation satellite system (GNSS) communication module, and/or a wired communication module, e.g., a local area network (LAN) communication module or a power line communication (PLC) module). The wireless communication module and/or the wired communication module may communicate with the electronic device via a short-range communication network or a long-range communication network. The short-range communication network may include near field communication (NFC), Bluetooth, wireless fidelity (WiFi) direct, and/or infrared data association (IrDA), as examples. The long-range communication network may include a legacy cellular network, a 5G network, a next-generation communication network, the Internet, and/or a computer network, e.g., a LAN or WAN, as examples. The wireless communication modules and/or wired communication modules may be implemented as a single component, e.g., a single chip, or may be implemented as multiple components, e.g., multiple chips separate from each other.

Referring back to FIG. 2, the battery management apparatus 300, which may also be a battery management system (BMS), may manage and/or control a state and/or an operation of the higher-level battery unit 100 and/or the plurality of battery units 110, 120, . . . , 130. For convenience of description, the higher-level battery unit 100 and/or one or more of the plurality of battery units 110, 120, . . . , 130 may be referred to as the battery unit 100.

The battery management apparatus 300 may determine the state of the battery unit 100 and manage the state of the battery unit 100 based on the determined state. The battery management apparatus 300 may control an operation of the battery unit 100 and manage the operation of the battery unit 100 based on the controlled operation.

The battery management apparatus 300 may monitor a voltage, a current, and/or a temperature of the battery unit 100. At least one sensor and/or any other measurement module (not shown) may be installed in any position of the battery unit 100 and/or charging/discharging path of the battery unit 100 for obtaining the voltage, current, and/or temperature of the battery unit 100.

The battery management apparatus 300 may calculate battery information regarding the state of the battery unit 100 based on a measurement value, such as the monitored voltage, current, and/or temperature. For example, the battery information regarding the state of the battery unit 100 may include at least one of a state of charge (SOC), a state of health (SOH), a resistance, a current cycle, a remaining prediction cycle, and/or a C-rate.

The operation of the battery management apparatus 300 may be performed in the battery management apparatus 300 and/or various devices such as a server, a cloud, a charger, and/or charger/discharger having the battery management apparatus 300 mounted thereon.

The battery management apparatus 300 may include a communication circuit 310, a sensor 320, a second memory 330, and a controller 340.

The communication circuit 310 may establish a wired communication channel and/or a wireless communication channel between the battery management apparatus 300 and another device and transmit and receive data through the established communication channel. The communication circuit 310 may transmit data to the communication module 150 included in the battery unit 100. For example, the communication circuit 310 of the battery management apparatus 300 may transmit the battery information and/or the battery identification information to the communication module 150 of the battery unit 100. The battery information and/or the battery identification information transmitted from the communication circuit 310 to the communication module 150 may be encrypted information.

The connection between the communication circuit 310 of the battery management apparatus 300 and the communication module 150 of the battery unit 100 may be communication connection through a wired and/or wireless network. The wired network may be based on a local area network (LAN) communication or a power-line communication. The wireless network may be based on a short-range communication network, e.g., Bluetooth, Wireless Fidelity (WiFi), and/or Infrared Data Association (IrDA), or a long-range communication network, e.g., a cellular network, a 4th-Generation (4G) network, and/or a 5th-Generation (5G) network.

The connection between the communication circuit 310 of the battery management apparatus 300 and the communication module 150 of the battery unit 100 may be connection using a device-to-device communication scheme, e.g., a bus, a general-purpose input and output (GPIO), a serial peripheral interface (SPI), and/or a mobile industry processor interface (MIPI)).

The sensor 320 may obtain information of the battery unit 100. The sensor 320 may obtain voltage, current, and/or temperature of the battery unit 100 in a charging, discharging, and/or rest process.

The second memory 330 may store data used by at least one component, e.g., the controller 340, of the battery management apparatus 300. For example, the data may include software or an instruction related thereto, input data, and/or output data. The instruction, when executed by the controller 340, may cause the battery management apparatus 300 to perform operations defined by the instruction. The second memory 330 may include a volatile and/or a nonvolatile memory.

The second memory 330 may store information related to an operation performed in the battery management apparatus 300. For example, the second memory 330 may store information obtained from the sensor 320. The second memory 330 may store battery identification information related to the battery unit 100. For example, the battery identification information may include information, e.g., the product serial number of the battery unit 100, for identifying the battery unit 100. Thus, the battery management apparatus 300 may identify the battery unit 100 through the stored battery identification information.

The second memory 330 may store the battery information calculated by the controller 340 or the battery information encrypted by the controller 340.

The controller 340 may calculate the battery information based on the information related to the state of the battery unit 100. The information related to the state of the battery unit 100 may be information obtained by the sensor 320 or information stored in the second memory 330. For example, the controller 340 may calculate one or more battery information regarding the SOC, the SOH, the resistance, the current cycle, the remaining prediction cycle, and/or the C-rate based on the voltage, current, and/or temperature of the battery unit 100.

The controller 340 may provide the calculated battery information to the user. For example, the controller 340 may provide battery information to a user terminal through the communication circuit 310 and also provide the battery information through a display provided in a vehicle and/or a charger.

The controller 340 may manage the battery information. The battery management apparatus 300 may encrypt the battery information regarding the battery unit 100. For example, the controller 340 may encrypt the battery information to manage the battery information.

The controller 340 may encrypt the battery information through various data encryption algorithms. As examples, the encryption algorithms may include a message-digest algorithm (MD5), a secure hash algorithm (SHA), a Rivest Shamir Adleman (RSA) algorithm, and/or an advanced encryption standard (AES). The controller 340 may encrypt the battery information by changing the data size, e.g., number of bits, and/or format of the battery information. The controller 340 may secure confidentiality, integrity, and/or authentication regarding the battery information through the encryption process.

The controller 340 may include a central processing unit, an application processor, a graphic processing unit, a neural processing unit (NPU), an image signal processor, a sensor hub processor, and/or a communication processor.

The battery management apparatus 300 may store the encrypted battery information about the battery unit 100 in the second memory 330 or transmit the same to another electronic device through the communication circuit 310. The battery management apparatus 300 may transmit the battery information while maintaining security of the battery information.

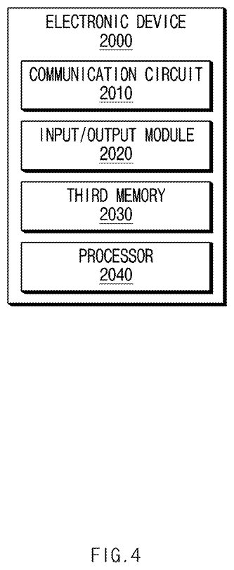

FIG. 4 depicts a block diagram of the electronic device 2000 according to aspects of the disclosure. The user may use a service provided by the server 3000 by using the electronic device 2000. For example, the service may include the battery passport service. To this end, an application for using the battery passport service may be installed in the electronic device 2000. The user may execute an application in the electronic device 2000 to subscribe to the battery passport service and register user information. For example, the user may register the user information such as user identification information, battery registration information, and/or access authority information regarding the battery passport information in an application. The user information may be stored in the electronic device 2000 and/or transmitted to the server 3000 and managed therein.

The user identification information may include various information for identifying the user such as a mobile phone number, a username, and/or password. The battery registration information may include the battery identification information used in the battery passport service. The battery registration information may include information about a battery included in a vehicle (not shown) or an ESS related to the user. For example, the battery registration information may include the battery identification information, e.g., a serial number of the battery unit 100, or may include vehicle identification information, e.g., a unique number of the vehicle, identification information of the ESS, e.g., a unique number of the ESS, and/or a serial number of a battery unit included therein.

When the user subscribing to the battery passport service accesses the battery pack 1000 while carrying the electronic device 2000, the electronic device 2000 may receive the battery identification information from the battery pack 1000. For example, the electronic device 2000 may receive the battery identification information from the battery pack 1000 through NFC communication. When the electronic device 2000 receives the battery identification information, the application may be automatically activated. The electronic device 2000 may transmit the user information and/or the battery identification information to the server 3000 through the activated application.

The electronic device 2000 may include a communication circuit 2010, an input/output module 2020, a third memory 2030, and a processor 2040.

The communication circuit 2010 may support establishment of a communication channel between the electronic device 2000 and another electronic device, e.g., the communication module 150, the battery management apparatus 300, the server 3000, and/or another electronic device (not shown). The communication channel may include a wired communication channel and/or a wireless communication channel.

The communication circuit 2010 may receive the battery information and the battery identification information from the communication module 150 included in the battery unit 100 of the battery pack 1000. The battery information and the battery identification information may be encrypted information. The communication circuit 2010 may transmit the user information, the battery information, and/or the battery identification information to the server 3000. The communication circuit 2010 may receive the user information and/or the battery passport information from the server 3000.

The communication circuit 2010 may include a wireless communication circuit for wireless communication and/or a wired communication circuit for wired communication. For example, the wireless communication circuit may include a cellular communication circuit, a short-range wireless communication circuit, or a global navigation satellite system (GNSS) communication circuit. For example, the wired communication circuit may include a local area network (LAN) communication circuit or a power line communication circuit. The wireless communication circuit and/or the wired communication circuit may communicate with the electronic device 2000 via a short-range communication network and/or a long-range communication network. The short-range communication network may include Bluetooth, WiFi direct, and/or IrDA, as examples. The long-range communication network may include a legacy cellular network, a 5G network, a next-generation communication network, Internet, and/or a computer network, e.g., an LAN or a WAN, as examples. The wireless communication circuit and/or wired communication circuit may be implemented as a single component, e.g., a single chip, or may be implemented as multiple components, e.g., multiple chips, separate from each other.

The communication circuit 2010 may include an NFC circuit and an antenna. For example, the NFC circuit may receive and process a received signal in the NFC frequency band, received via the NFC antenna, and process a transmission signal in the NFC frequency band for transmission via the NFC antenna. For example, the NFC antenna may receive a signal in a frequency band of 13 MHz to 110 MHz. The NFC antenna may include a conductive wire capable of receiving a signal in the frequency band of 13 MHz to 110 MHz, and the conductive wire may be implemented in a closed-loop form including a plurality of turns. For example, the NFC antenna may transmit and receive an NFC signal in the frequency band of 13.56 MHz, receive a signal in another frequency band, or generate a magnetic field.

When the communication module 150 is an NFC communication module, the communication circuit 2010 may transmit and receive an NFC signal in the frequency band of 13 MHz to 110 MHz. The communication circuit 2010 of the electronic device 2000 may transmit the user information to the communication module 150 in the battery pack 1000 in a contactless manner through an NFC scheme. The communication circuit 2010 of the electronic device 2000 may receive the battery identification information and the battery information from the communication module 150 in the battery pack 1000 in the contactless manner through the NFC scheme. Even when the battery management apparatus 300 of the battery pack 1000 does not operate, the communication circuit 2010 of the electronic device 2000 may receive the battery information stored in the first memory 153 of the communication module 150.

The input/output module 2020 may receive a command or data to be used by another component, e.g., the processor 2040, of the electronic device 2000 from a user of the electronic device 2000 or output the same from the electronic device 2000. The input/output module 2020 may include an input module and/or an output module. For example, the input module may include, for example, a microphone, a mouse, a keyboard, a key, e.g., a button, and/or a digital pen, e.g., a stylus pen. The output module may include an audio output module and/or a display module. The audio output module may output an audio signal from the electronic device 2000. The audio output module may include, for example, a speaker and/or a receiver. The display module may visually provide information to a user of the electronic device 2000. The display module may include, for example, a display, a hologram device, or a projector, and/or a control circuit for controlling the electronic device 2000.

The input/output module 2020 may receive information from the user of the electronic device 2000. For example, the input/output module 2020 may receive the user information such as information related to identifying the user of the electronic device 2000, unique identification information for identifying the user, and/or user account information, e.g., account information for accessing a battery passport service application.

The third memory 2030 may store various data used by at least one component, e.g., the processor 2040, of the electronic device 2000. The data may include input data and/or output data for the software or command. The third memory 2030 may include volatile memory and/or non-volatile memory. The third memory 2030 may store a program as software. For example, the third memory 2030 may include an operating system, middleware, and/or an application.

The third memory 2030 may store information received from the battery unit 100. For example, the third memory 2030 may store the battery information of the battery unit 100. The third memory 2030 may include an application for using the battery passport service. The third memory 2030 may store information used for execution of the application. For example, the third memory 2030 may store the user information, the battery identification information, the battery information, and/or the battery passport information.

The processor 2040 may execute, for example, software stored in the third memory 2030, e.g., a program, to control at least one other component, e.g., a hardware or software component, of the electronic device 2000, or may perform various data processing or computations. For example, as at least part of the data processing or computations, the processor 2040 may store a command or data received from another component, e.g., the communication circuit 2010, in the volatile memory, process the command or the data stored in the volatile memory, and store resulting data in the non-volatile memory.

The processor 2040 may perform various operations performed in the application for using the battery passport. For example, the processor 2040 may identify and/or authenticate the user of the electronic device 2000 and manage the user information. The processor 2040 may manage the user information, the battery identification information, the battery information, and/or the battery passport information. The processor 2040 may decrypt the encrypted battery information.

The processor 2040 may include a main processor, e.g., a CPU or an application processor. The processor 2040 may also include an auxiliary processor, e.g., a GPU, an NPU, an image signal processor (ISP), a sensor hub processor, and/or a communication processor, capable of operating independently of or together with the main processor. For example, when the electronic device 2000 includes the main processor and the auxiliary processor, the auxiliary processor may be adapted to consume less power than the main processor, or be specific to a specified function. The auxiliary processor may be implemented separate from or as part of the main processor.

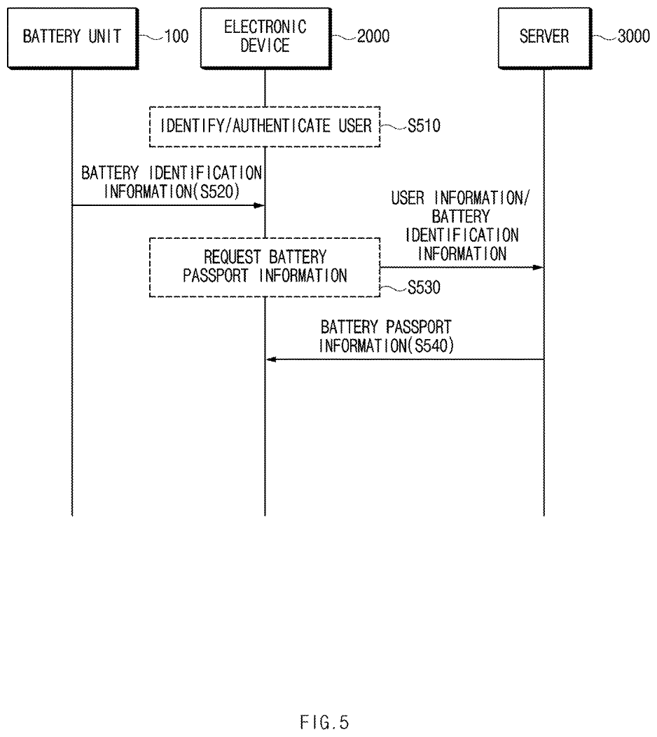

FIGS. 5-7 depict swim diagrams for various operating methods of the electronic device 2000 according to aspects of the disclosure. The various operating methods may be performed by the processor 2040 as depicted in FIG. 4.

FIG. 5 depicts a swim diagram for an operating method of the electronic device 2000 for requesting battery passport information according to aspects of the disclosure.

The operating method of the electronic device 2000 includes operation S510 of identifying and/or authenticating the user, operation S520 of receiving the battery identification information from the battery unit 100, operation S530 of requesting the battery passport information the server 3000 based on the user information and the battery identification information, and operation S540 of receiving at least a part of the battery passport information from the server 3000.

In operation S510, the processor 2040 may identify and/or authenticate the user of the electronic device 2000. For example, the processor 2040 may identify whether the user of the electronic device 2000 has an authority or is subscribed to the battery passport service. Such user identification/authentication may be performed through the application for using the battery passport service. For example, the processor 2040 may identify/authenticate the user by comparing a value input through the input/output module 2020 with a previously stored value. According to an embodiment, the processor 2040 may identify/authenticate the user of the electronic device 2000 by using subscriber information, e.g., an international mobile subscriber identity (IMSI)) stored in the application or the server 3000.

The processor 2040 may obtain the user information through the user identification/authentication. The user information may be stored in the electronic device 2000 or in the server 3000. The user information may be information related to an identity of the user of the electronic device 2000. For example, the user information may include information such as the user identification information, the battery registration information, and/or the access authority information. Alternatively, or additionally, the user information may include information related to the identity of the user of the electronic device 2000 or unique identification information for identifying the user. For example, the user information may differ from user to user.

The processor 2040 may receive data from the battery unit 100 when the user of the electronic device 2000 is an identified or authenticated user. In this way, the processor 2040 may maintain security of data transmitted to the electronic device 2000.

In operation S520, the electronic device 2000 may receive the battery identification information from the battery unit 100. For example, the battery identification information may be transmitted from the communication IC 151 of the battery unit 100 to the communication circuit 2010 of the electronic device 2000 and to the processor 2040 of the electronic device 2000.

The processor 2040 may receive the battery identification information stored in the first memory 153 of the communication module 150 of the battery unit 100. The battery identification information may include information, e.g., the serial number of the battery unit 100, for identifying the battery unit 100 including the communication module 150.

The battery identification information may be transmitted through the NFC scheme. For example, the battery identification information may be stored in the first memory 153 of the communication module 150 of the battery unit 100. When the user brings the electronic device 2000 close to the battery unit 100, the battery identification information may be transmitted to the electronic device 2000 from the battery unit 100. Thus, the communication module 150 may communicate with the external electronic device 2000 independently of the operating state of the battery management apparatus 300. In this way, the communication module 150 may transmit and receive various data including the battery identification information to and from the electronic device 2000 when the battery management apparatus 300 does not operate.

When the electronic device 2000 and the battery unit 100 are close to each other, the application for using the battery passport service may be automatically activated. Thus, the electronic device 2000 may receive the battery identification information through the application.

In operation S530, the processor 2040 of the electronic device 2000 may request the battery passport information to the server 3000 based on the user information and the battery identification information. The battery passport information may be information related to the management history of the battery unit 100.

The battery passport information may include information related to product data of the battery unit 100. For example, the battery passport information may include at least one of production information, use information, recycling information, and/or warranty information of the battery unit. The battery passport information may include information related to a service for the battery unit 100. The service for the battery unit 100 may include a service for reading and/or analyzing data of the battery unit 100.

The battery passport information may include information for replacing or exchanging the battery unit 100. For example, the battery passport information may include chemical product declaration information, chemical product safety information, analysis certificate information, emission information, product carbon footprint information, product environmental footprint information, chemical product specification information, product information, part information, technical application information, production information, material composition information, and/or recycling information.

The battery passport information may include various information including when the battery passport information is generated, when the battery passport information is modified last and/or expires, and/or when at least one component of the battery unit 100 is manufactured or shipped.

The processor 2040 may request at least a part of the battery passport information from the server 3000 based on the user information and the battery identification information, related to the user, in response to a request from the user.

The user information may include information about a user type. The user information may include the access authority information about the battery passport information. The type of the user may include the public, a stakeholder, an executive committee, a certification authority, and/or a market surveillance authority, as examples.

The public may be an ordinary user who purchases and uses the battery unit 100. The stakeholder may be a user related to manufacturing, remanufacturing, reuse, recycling, repair, and/or disassembly of the battery unit 100. The executive committee may be an institution for resolution and enactment of legislation. The authentication institution may be an institution for issuing an electronic identity card or security certificate. The market surveillance authority may be an agency for preventing and regulating unfair trades.

The processor 2040 may request at least partial information corresponding to access authority of a user in the battery passport information, based on the access authority information of the user information. For example, the processor 2040 may request the battery passport information accessible to the public to the server 3000 when the access authority of the user information is the public. The processor 2040 may request the battery passport information based on the user information and the battery identification information, thereby giving an access authority selective to the battery passport information to the user. Moreover, as the processor 2040 requests a part of the battery passport information corresponding to the user authority, the electronic device 2000 may receive a small amount of information from the server 3000. In this way, the electronic device 2000 may efficiency receive information required for the user.

The processor 2040 may request information accessible to the public in the battery passport information to the server 3000 when the user access authority is the public. For example, information accessible to the public in the battery passport information may include information included in Table 1 below.

TABLE 1

| Classification | Required Information | Classification | Required Information |
|---|---|---|---|
| (a) | Information included in a | (p) | Round trip energy efficiency at |
| | battery label (Annex VI - | | initial and 50% of cycle-life |
| | Part A) | (q) | Internal battery cell and pack |
| | Manufacturer name, brand | | resistance |
| | name or trademark, address, | (r) | C-rate of relevant cycle-life test |
| | single contact, website, e- | (s) | Separation collection mark |
| | mail address | | |
| | Element for identifying | | |
| | battery, such as battery | | |
| | category, model identifier, | | |
| | batch or S/N or product | | |
| | number | | |
| | Manufacturing location | | |
| | and manufacturing date | | |
| | Weight and capacity | | |
| | Chemical composition | | |
| | Harmful substances | | |
| | included in battery other | | |
| | than mercury, cadmium, | | |
| | and lead | | |
| (b) | Battery composition | (t) | EU conformity assessment |
| | including critical raw | | statement |
| | material | | |
| (f) | Carbon footprint | (u) | Information related to |
| | information (carbon | | prevention and management of |
| | footprint reporting and | | waste battery |
| | carbon footprint | | |
| | performance rating) | | |
| (g) | Responsible sourcing | | |
| | information according to | | |
| | Art 45e(3) | | |
| (h) | Recycling material | | |
| | information | | |
| (ha) | Renewable material content | | |
| | (share of renewable | | |
| | contents) | | |
| (i) | Rated capacity (in Ah) | | |
| (j) | Minimal, nominal and | | |
| | maximum voltage | | |
| (k) | Original power capability | | |
| | and limitation (indicated by | | |
| | Watts) | | |
| (f) | Battery predicted lifetime | | |
| | (indicated by cycle) | | |
| (m) | Capacity threshold for | | |
| | exhaustion (corresponding | | |
| | to EV battery) | | |
| (n) | Temperature range the | | |
| | battery can withstand when | | |
| | not in use | | |
| (o) | Commercial warranty | | |
| | period (for the calendar life | | |
| | applies) | | |

Referring to Table 1, when the access authority is the public, the processor 2040 may request, from the server 3000, information related to manufacturing information, warranty information, composition information, material information, carbon footprint information, predicted lifetime information, recycled material information, capacity information, voltage information, power information, temperature information, energy efficiency information, resistance information, C-rate information, cycle information, separate collection information, EU conformity assessment information, information related to waste battery prevention and management, and/or renewable material content information of the battery unit 100 in the battery passport information.

When the user access authority is the stakeholder or the execution committee, the processor 2040 may request information accessible to the stakeholder or the execution committee in the battery passport information to the server 3000. For example, information accessible to the stakeholder or the execution committee in the battery passport information may include information included in Table 2 and Table 3.

TABLE 2

| Classification | Battery model-related information |
|---|---|
| (a) | Detailed composition, including materials |
| | used in cathode, anode and electrolyte |
| (b) | Part numbers for components and contact |
| | details of sources for replacement spares |
| (c) | Dismantling information, including at least: |
| | Exploded view of battery system/pack |
| | showing positions of battery cells |
| | Type of engaging method and quantity |
| | Tool for disassembly |
| | Warning for risk of damage to components |
| | Cell quantity and layout |
| (d) | Safety measures |

TABLE 3

| Classification | Information about individual batteries |
|---|---|
| (a) | Performance and durability information for Article 10(1) (at the time of |
| | battery release and whenever there is a change in state)1. Rated |
| | capacity (in Ah) and capacity fade (in %). |
| | 2. Power (in W) and power fade (in %). |
| | 3. Internal resistance (in Ω) and internal resistance increase (in %). |
| | 4. Where applicable, energy round trip efficiency and its fade (in %). |
| | 5. Their expected lifetime under the reference conditions for which |
| | they have been designed in terms of cycles, except for non-cycle applications, |
| | and calendar years. |
| (aa) | SOH related information of Article 14 |
| | [EV Battery] State of certified energy (SOCE) |
| | [ESS and LMT batteries] |
| | 1. Remaining capacity |
| | 2. If possible, remaining power capability |
| | 3. If possible, remaining round trip efficiency |
| | 4. Evolution of self-discharging rates |
| | 5. If possible, ohmic resistance |
| (b) | Information about battery state (original, repurposed, reused, remanufactured, |
| | or waste) |
| (c) | Battery use history including the number of charging/discharging cycles, |
| | history of adverse events, periodically recorded operating environment and |
| | SOC information |
| (h) | Recycling material information |
| (ha) | Renewable material content (share of renewable contents) |
| (i) | Rated capacity (in Ah) |

Referring to Table 2 and Table 3, for example, when the access authority is the stakeholder or the execution committee, the processor 2040 may request, from the server 3000, information related to composition information, part replacement information, removal information, state information, information for safety measures, performance information, durability information, SOH/SOC information, use history information, recycling material information, capacity information, and/or renewable material content information in the battery passport information.

When the access authority is the certification authority, the market surveillance authority, or the execution committee, the processor 2040 may request information accessible to the certification authority, the market surveillance authority, or the execution committee in the battery passport information from the server 3000. For example, information accessible to the certification authority, the market surveillance authority, or the execution committee in the battery passport information may include information included in Table 4 below.

TABLE 4

| | |
|---|---|
| Classification | Information accessible to certification |
| | authority, market surveillance authority, |
| | and execution committee |
| (a) | Results of tests reports proving compliance |
| | with the requirements set out in this |
| | Regulation or any implementing or delegated |
| | act adopted on its basis |

Referring to Table 4, for example, when the access authority is the certification authority, the market surveillance authority, or the execution committee, the processor 2040 may request, from the server 3000, information related to information regarding law compliance in the battery passport information. The information regarding law compliance may include test reports for checking law compliance to requirements in the battery passport related legislation.

In operation S540, the electronic device 2000 may receive the battery passport information from the server 3000. The processor 2040 may receive the battery passport information corresponding to the access authority from the server 3000. The processor 2040 may receive at least a part of the battery passport information corresponding to the access authority, thereby reducing the amount of the battery passport information and improving transmission speed. The processor 2040 may also receive some information other than the entire battery passport information stored in the server 3000 according to the access authority, thereby improving the security of the battery passport information.

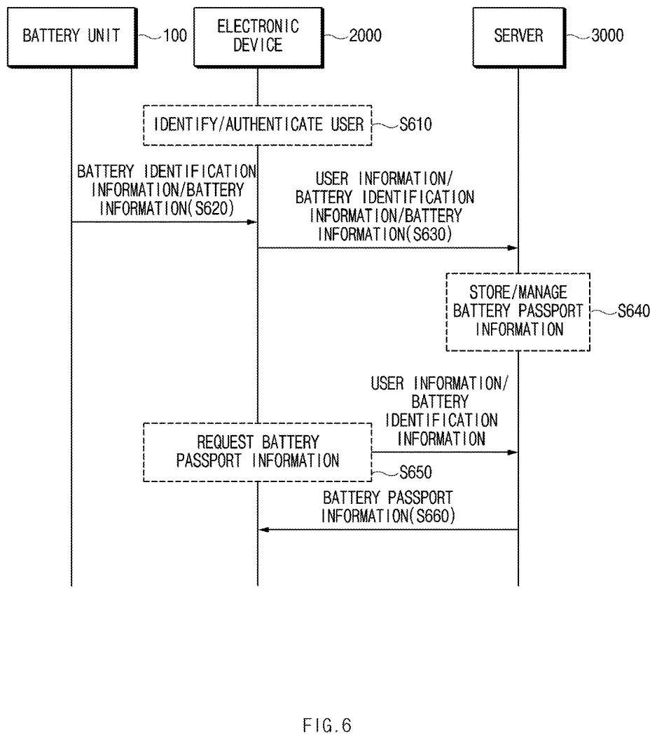

FIG. 6 depicts a swim diagram for an operating method of the electronic device 2000 for storing battery passport information according to aspects of the disclosure.

The operating method of the electronic device 2000 includes operation S610 of identifying and/or authenticating the user, operation S620 of receiving battery identification information and battery information from the battery unit 100, operation S630 of transmitting user information, the battery identification information, and the battery information to the server 3000, operation S640 of storing and/or managing the battery passport information, operation S650 of requesting the battery passport information to the server 3000 based on the user information and the battery identification information, and operation S660 of receiving at least a part of the battery passport information from the server 3000.

In operation S610, the processor 2040 may identify and/or authenticate the user of the electronic device 2000. Such user identification/authentication may be performed through the application for using the battery passport service. The processor 2040 may obtain the user information through the user identification/authentication. Operation S610 may correspond to operation S510 as depicted in FIG. 5.

In operation S620, the electronic device 2000 may receive the battery identification information and the battery information from the battery unit 100. For example, the battery identification information and the battery information may be transmitted from the communication IC 151 of the battery unit 100 to the communication circuit 2010 of the electronic device 2000 and may be provided to the processor 2040 of the electronic device 2000.

The processor 2040 of the electronic device 2000 may receive the battery identification information and the battery information stored in the first memory 153 of the communication module 150 of the battery unit 100. The battery identification information may include information, e.g., the serial number of the battery unit 100, for identifying the battery unit 100 including the communication module 150. The battery information may include information related to the use history of the battery unit 100 or the state of the battery unit 100.

The battery identification information and the battery information may be transmitted in the NFC manner. For example, the battery identification information and the battery information may be stored in the first memory 153 of the communication module 150 of the battery unit 100. When the user brings the electronic device 2000 close to the battery unit 100, the battery identification information and the battery information may be transmitted to the electronic device 2000 from the battery unit 100. Thus, the communication module 150 may communicate with the electronic device 2000 independently of the operating state of the battery management apparatus 300. In this way, the communication module 150 may transmit and receive the battery identification information and the battery information to and from the electronic device 2000 when the battery management apparatus 300 does not operate.

When the electronic device 2000 and the battery unit 100 are close to each other, the application for using the battery passport service may be automatically activated. Thus, the electronic device 2000 may receive the battery identification information and the battery information through the application.

In operation S630, the processor 2040 of the electronic device 2000 may transmit the user information, the battery identification information, and the battery information to the server 3000. The processor 2040 of the electronic device 2000 may transmit the battery information to the server 3000 such that the battery information regarding the battery unit 100 is managed as the battery passport information of the battery unit 100. The battery passport information may be information related to the management history of the battery unit 100. For example, the battery passport information may include production information, use information, recycling information, and/or warranty information of the battery unit.

The processor 2040 may transmit the battery information received from the battery unit 100 to the server 3000, regardless of the access authority of the user information. In this way, the processor 2040 may update the latest information about the battery unit 100 in the battery passport information, regardless of the user of the electronic device 2000. Thus, the processor 2040 may accurately manage the battery passport information.

In operation S640, the server 3000 may store and/or manage the battery passport information. For example, the server 3000 may update the battery passport information based on the provided user information, battery identification information, and battery information. The server 3000 may store the battery information in the battery passport information corresponding to the battery identification information. The server 3000 may classify and store a type of the battery information. Thus, the server 3000 may manage the battery information as the battery passport information. In this way, the server 3000 may keep the battery passport information up to date. At the request of the user, the server 3000 may provide the battery passport information to the user. Thus, the user may manage the battery unit 100 through the latest battery passport information.

In operation S650, the processor 2040 of the electronic device 2000 may request the battery passport information from the server 3000 based on the user information and the battery identification information. The battery passport information may be information related to the management history of the battery unit 100. The processor 2040 may request at least a part of the battery passport information to the server 3000 based on the user information and the battery identification information, related to the user, in response to a request from the user.

In operation S660, the electronic device 2000 may receive the battery passport information from the server 3000. The processor 2040 may receive the battery passport information corresponding to the user access authority from the server 3000. The processor 2040 may receive at least a part of the battery passport information corresponding to the user access authority, thereby reducing the amount of the battery passport information and improving transmission speed. The processor 2040 may also receive some information other than the entire battery passport information stored in the server 3000 according to the user access authority, thereby improving the security of the battery passport information.

Operations S610 to S640 described with reference to FIG. 6 are also applicable to when the battery unit 100, the electronic device 2000, and/or the server 3000 are implemented by a different manufacturer. For example, the server 3000 may be a higher-level server 3000 that stores/manages the battery passport information regarding the battery units 100 of different manufacturers. As the battery passport information is managed in the higher-level server 3000, the user may easily manage the battery units 100 of various manufacturers.

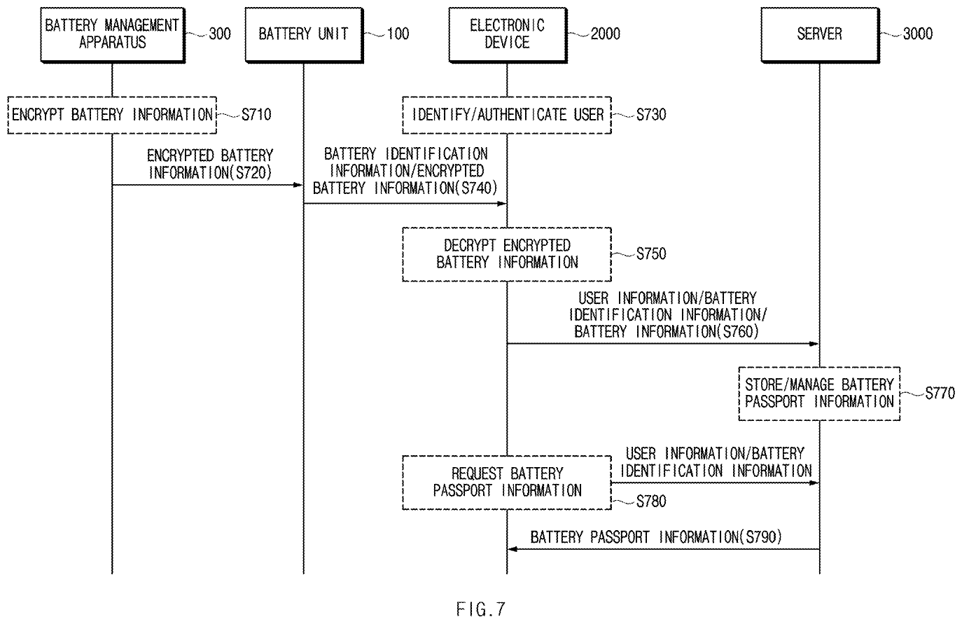

FIG. 7 depicts a swim diagram for an operating method of the electronic device 2000 for encrypting/decryption battery information according to aspects of the disclosure. The operating method of the electronic device 2000 includes operation S710 of encrypting battery information, operation S720 of receiving encrypted battery information, operation S730 of identifying and/or authenticating the user, operation S740 of receiving battery identification information and encrypted battery information from the battery unit 100, operation S750 of decrypting the encrypted battery information, operation S760 of transmitting user information, the battery identification information, and the battery information to the server 3000, operation S770 of storing and/or managing the battery passport information, operation S780 of requesting the battery passport information to the server 3000 based on the user information and the battery identification information, and operation S790 of receiving at least a part of the battery passport information from the server 3000.

In operation S710, the battery management apparatus 300 may encrypt the battery information. The controller 340 of the battery management apparatus 300 may encrypt the battery information to generate the encrypted battery information. For example, the controller 340 may encrypt the battery information through various data encryption algorithms. As the controller 340 of the battery management apparatus 300 encrypts the battery information, the controller 340 may improve the stability of the battery information and the security of communication.

In operation S720, the battery unit 100 may receive the encrypted battery information. The communication circuit 310 of the battery management apparatus 300 may transmit the encrypted battery information to the communication module 150 of the battery unit 100.

The battery unit 100 may store the encrypted battery information. For example, the encrypted battery information received in the communication module 150 of the battery unit 100 may be stored in the first memory 153 of the communication module 150.

In operation S730, the electronic device 2000 may identify and/or authenticate the user.

In operation S740, the electronic device 2000 may receive the encrypted battery information and the battery identification information from the battery unit 100. For example, the communication circuit 2010 of the electronic device 2000 may receive the encrypted battery information and the battery identification information regarding the battery unit 100 from the communication module 150 of the battery unit 100.

In operation S750, the electronic device 2000 may decrypt the encrypted battery information. For example, the processor 2040 of the electronic device 2000 may decrypt the encrypted battery information. The processor 2040 may decrypt the encrypted battery information through various data decryption algorithms. The controller 340 may decrypt the encrypted battery information by changing the data size and/or format of the encrypted battery information.

The processor 2040 of the electronic device 2000 may decrypt the encrypted battery information through an application for using the battery passport service. The application may include a program for executing a decryption operation. As the decryption operation is performed in the application, the application may manage the security of data transmission among the battery management apparatus 300, the battery unit 100, and the electronic device 2000.

In operation S760, the decrypted battery information, the battery identification information, and the user information may be transmitted to the server 3000. For example, the processor 2040 of the electronic device 2000 may may transmit the battery information to the server 3000 such that the decrypted battery information is managed as the battery passport information.

In operation S770, the server 3000 may store and/or manage the battery passport information. For example, the server 3000 may manage the battery passport information based on the provided battery information, battery identification information, and user information. In operation S780, the electronic device 2000 may request the battery passport information from the server 3000 based on the user information and the battery identification information. In operation S790, the electronic device 2000 may receive at least a part of the battery passport information from the server 3000. Operations S770 to S790 may correspond to operations S640 to S660 as depicted in FIG. 5.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. An electronic device comprising:
a communication circuit configured to communicate with a communication module of a battery unit; and
a processor configured to:
receive battery identification information regarding the battery unit from the communication module;
receive a request from a user; and
in response to receiving the request from the user, request, from a server, at least a part of battery passport information related to a management history of the battery unit, based on user information related to the user and the battery identification information.

2. The electronic device of claim 1, wherein the processor is further configured to:
receive battery information regarding the battery unit from the communication module; and
transmit the battery information to the server such that the battery information is managed as the battery passport information of the battery unit.

3. The electronic device of claim 1, wherein the user information comprises access authority information regarding the battery passport information.

4. The electronic device of claim 3, wherein the processor is further configured to receive battery passport information corresponding to an access authority of the user from the server.

5. The electronic device of claim 12, wherein the communication module comprises a near field communication (NFC) module.

6. The electronic device of claim 5, wherein the NFC module comprises memory configured to store the battery identification information and the battery information.

7. The electronic device of claim 6, wherein the processor is further configured to:
receive encrypted battery information stored in the first memory of the NFC module; and
decrypt the encrypted battery information.

8. The electronic device of claim 1, wherein the battery passport information comprises at least one of production information, use information, recycling information, or warranty information of the battery unit.

9. The electronic device of claim 3, wherein the processor is further configured to request, from the server, information related to at least one of manufacturing information, warranty information, material information, predicted lifetime information, or renewable material content information of the battery unit in the battery passport information, when the access authority of the user corresponds to a first access authority.

10. The electronic device of claim 9, wherein the processor is further configured to request, from the server, information related to at least one of composition information, part replacement information, removal information, state information, or renewable material content information of the battery unit in the battery passport information, when the access authority of the user corresponds to a second access authority.

11. The electronic device of claim 10, wherein the processor is further configured to request information related to information about law compliance of the battery unit in the battery passport information, when the access authority of the user corresponds to a third access authority.

12. A battery pack comprising:
a battery unit comprising a communication module; and
a battery management apparatus communicating with the communication module;
wherein the communication module comprises a processor configured to:
communicate with an electronic device independently of an operating state of the battery management apparatus;
receive battery information regarding the battery unit from the battery management apparatus; and
transmit the battery information and battery identification information regarding the battery unit to the electronic device.

13. The battery pack of claim 12, wherein:
the battery management apparatus comprises:
a first memory configured to store the battery information regarding the battery unit; and
a controller configured to encrypt the battery information; and
the communication module further comprises a second memory configured to store battery information encrypted in the battery management apparatus.

14. An operating method of an electronic device comprising:
receiving, by a processor, battery identification information regarding the battery unit from a communication module of a battery unit;
receiving, by the processor, a request from a user; and
in response to receiving the request from the user, requesting, by the processor, from a server, at least a part of battery passport information related to a management history of the battery unit, based on user information related to a user and the battery identification information.

15. The operating method of claim 14, further comprising:
receiving, by the processor, battery information regarding the battery unit from the communication module; and
transmitting, by the processor, the battery information to the server such that the battery information is managed as the battery passport information of the battery unit.

16. The operating method of claim 14, wherein:
the user information comprises access authority information regarding the battery passport information; and
the operating method further comprises receiving battery passport information corresponding to an access authority of the user from the server.

17. The operating method of claim 15, further comprising:
receiving, by the processor, encrypted battery information stored in a first memory of the communication module; and
decrypting, by the processor, the encrypted battery information.

18. The operating method of claim 14, wherein;
the user information comprises access authority information regarding the battery passport information; and
the requesting of the at least a part of the battery passport information comprises requesting, from the server, information related to at least one of manufacturing information, warranty information, material information, predicted lifetime information, or renewable material content information of the battery unit in the battery passport information, when the access authority of the user corresponds to a first access authority.

19. The operating method of claim 18, wherein;
the requesting of the at least a part of the battery passport information comprises requesting, from the server, information related to at least one of composition information, part replacement information, removal information, state information, or renewable material content information of the battery unit in the battery passport information, when the access authority of the user corresponds to a second access authority.

20. The operating method of claim 19, wherein;
the requesting of the at least a part of the battery passport information comprises requesting information related to information about law compliance of the battery unit in the battery passport information, when the access authority of the user corresponds to a third access authority.
